(19) United States
(12) Patent Application Publication
(10) Pub. No.: US 2026/0290856 A1
(43) Pub. Date: Sep. 24, 2026

(54) FUEL CELL SEALING STRUCTURE

(71) Applicant: TOYOTA JIDOSHA KABUSHIKI KAISHA, Toyota-shi (JP)

(72) Inventors: Atsuhiro MIURA, Toyota-shi (JP); Takuya KURIHARA, Miyoshi-shi (JP); Yuki MIMURA, Okazaki-shi (JP); Kaoru MINAGAWA, Toyota-shi (JP); Naoki OGIWARA, Nagoya-shi (JP)

(73) Assignee: TOYOTA JIDOSHA KABUSHIKI KAISHA, Toyota-shi (JP)

(21) Appl. No.: 19/532,682

(22) Filed: Feb. 6, 2026

(30) Foreign Application Priority Data
Mar. 19, 2025 (JP) 2025-044349

(51) Int. Cl. H01M 8/0276; H01M 8/0284; H01M 8/0286; H01M 8/2485

(52) U.S. Cl. CPC H01M 8/0276; H01M 8/0284; H01M 8/0286; H01M 8/2485

(57) ABSTRACT

A fuel cell sealing structure includes a positioning portion in which a sealing member is positioned and that is bonded to the sealing member; and an adhesive layer positioned between the positioning portion and the sealing member and configured to bond the positioning portion and the sealing member to each other. The adhesive layer includes, in a width direction of the sealing member, a first portion and a second portion, the second portion having a thickness smaller than a thickness of the first portion or being a void.

### CROSS REFERENCE TO RELATED APPLICATIONS

This application claims the benefit of priority to Japanese Patent Application No. 2025-044349, filed on March 19, 2025, the entire contents of which are incorporated herein by reference in their entirety.

### BACKGROUND

### FIeld

The present disclosure relates to a fuel cell sealing structure.

### Related Art

Regarding a fuel cell sealing structure, Japanese Patent Application Publication No. 2004-55276 discloses a technology for bonding an annular gasket to a sealing surface via an adhesive.

In fuel cell sealing structures, there is a demand for further enhancing the bonding strength of a sealing member. For example, simply increasing the thickness of an adhesive layer containing an adhesive to enhance the bonding strength results in an increased amount of adhesive used. Accordingly, there is a need for a technology capable of enhancing bonding strength while suppressing an increase in the amount of adhesive used.

### SUMMARY

According to one aspect of the present disclosure, a fuel cell sealing structure is provided. The fuel cell sealing structure includes: a sealing member; a positioning portion in which the sealing member is positioned, the positioning portion being bonded to the sealing member; and an adhesive layer positioned between the positioning portion and the sealing member and configured to bond the positioning portion and the sealing member to each other. The adhesive layer includes, in a width direction of the sealing member, a first portion and a second portion, the second portion having a thickness smaller than a thickness of the first portion or being a void.

### BRIEF DESCRIPTION OF THE DRAWINGS

FIG. 1 is an explanatory diagram showing a schematic configuration of a fuel cell in a first embodiment.

FIG. 2 is an explanatory diagram of a fuel cell sealing structure in the first embodiment.

FIG. 3 is a process diagram showing a method for manufacturing the fuel cell sealing structure.

FIG. 4 is an explanatory diagram of a fuel cell sealing structure in a second embodiment.

FIG. 5 is an explanatory diagram of a fuel cell sealing structure in a third embodiment.

FIG. 6 is an explanatory diagram of a fuel cell sealing structure in a fourth embodiment.

### DETAILED DESCRIPTION

### First Embodiment

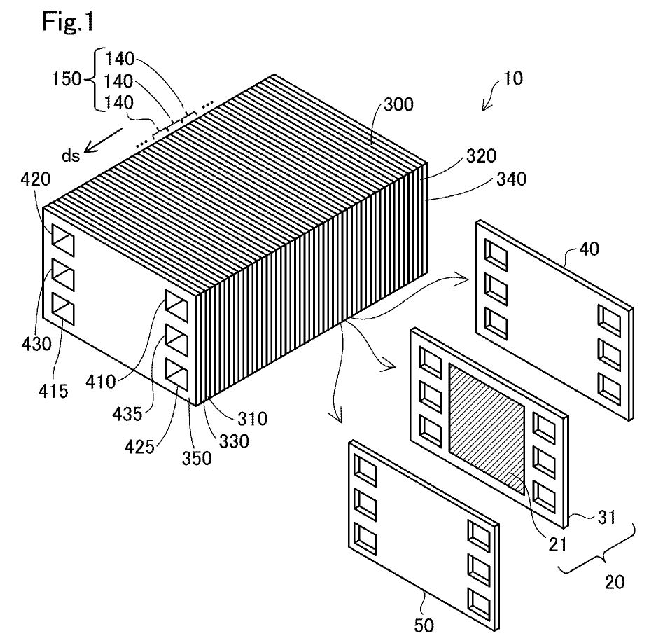

FIG. 1 is an explanatory diagram showing a schematic configuration of a fuel cell 10 in a first embodiment. The fuel cell 10 includes a stack body 150, a pair of terminal plates 300 and 310, a pair of insulating plates 320 and 330, and a pair of end plates 340 and 350. The stack body 150 is composed of a plurality of single cells 140 stacked in a stacking direction ds. The terminal plates 300 and 310 clamp the stack body 150 in a Z-direction. The insulating plates 320 and 330 are positioned in contact with the terminal plates 300 and 310 from their outside in the Z-direction. The end plates 340 and 350 are positioned in contact with the insulating plates 320 and 330 from their outside in the Z-direction, respectively. The fuel cell 10 is configured to have a stacked structure by being fastened in the stacking direction ds using a fastening member (not shown). The stacking direction ds is a direction orthogonal to a plane direction of each single cell 140. In the fuel cell 10, which has a stacked structure, each of the single cells 140 is held while a fastening pressure is applied by a fastening force along the stacking direction ds.

The fuel cell 10 is a polymer electrolyte fuel cell that generates electricity by being supplied with an anode gas containing hydrogen and a cathode gas containing oxygen. Electrical power generated by an electrochemical reaction in the fuel cell 10 is collected at the terminal plates 300 and 310 and output to an external load via terminals provided on the terminal plates 300 and 310.

As shown in FIG. 1, the fuel cell 10 includes an anode gas supply manifold 410 through which the anode gas is supplied to the fuel cell 10 and an anode gas discharge manifold 415 through which the anode gas is discharged from the fuel cell 10. Similarly, the fuel cell 10 includes a cathode gas supply manifold 420 and a cathode gas discharge manifold 425 through which the cathode gas is supplied or discharged, respectively, and a coolant supply manifold 430 and a coolant discharge manifold 435 through which the coolant is supplied or discharged, respectively. Each manifold is configured to penetrate the end plate 350, the insulating plate 330, the terminal plate 310, and all of the stacked single cells 140.

Each single cell 140 includes a Membrane Electrode Gas-diffusion-layer Assembly (MEGA) plate 20 and a pair of separators 40 and 50. The MEGA plate 20 includes a MEGA 21 and a resin sheet 31 joined to the periphery of the MEGA 21.

The MEGA 21 includes a Membrane Electrode Assembly (MEA) and a pair of gas diffusion layers sandwiching the MEA. The MEA includes an electrolyte membrane, and an anode electrode catalyst layer and a cathode electrode catalyst layer that are positioned on both opposite surfaces of the electrolyte membrane, with one catalyst layer on each side. The electrolyte membrane is a solid polymer thin membrane exhibiting favorable proton conductivity in a wet state. The electrolyte membrane may be composed of an ion-exchange membrane made of a fluorine-based resin, for example. The catalyst layers include a catalyst promoting a chemical reaction between hydrogen and oxygen, and carbon particles supporting the catalyst. The gas diffusion layers are provided adjacent to corresponding surfaces of the respective catalyst layers. Each gas diffusion layer is configured to diffuse a reaction gas used for an electrode reaction, along the plane direction of the electrolyte membrane and is composed of a porous diffusion-layer substrate. Examples of the diffusion-layer substrate suitably used include porous substrates having both electrical conductivity and gas diffusivity, such as carbon fiber substrates, graphite fiber substrates, and foamed metals.

In the present embodiment, the resin sheet 31 is formed of polyethylene terephthalate (PET). In other embodiments, the resin sheet 31 may be formed of other various thermoplastic resin materials, such as polypropylene or polyethylene. The resin sheet 31 is provided with slit-shaped gas introduction paths (not shown) that connect the respective manifolds to the MEGA 21. Each gas introduction path is formed, for example, to penetrate the resin sheet 31.

The separators 40 and 50 sandwich the MEGA plate 20 in a direction along the stacking direction ds. In the following description, a direction oriented from the separator 40 toward the separator 50 in the stacking direction ds is also referred to as a downward direction, while a direction oriented from the separator 50 toward the separator 40 is also referred to as an upward direction. That is, the separator 40 is located above the separator 50. In the present embodiment, the separators 40 and 50 are made of stainless steel. In other embodiments, the separators 40 and 50 may be made of titanium, for example.

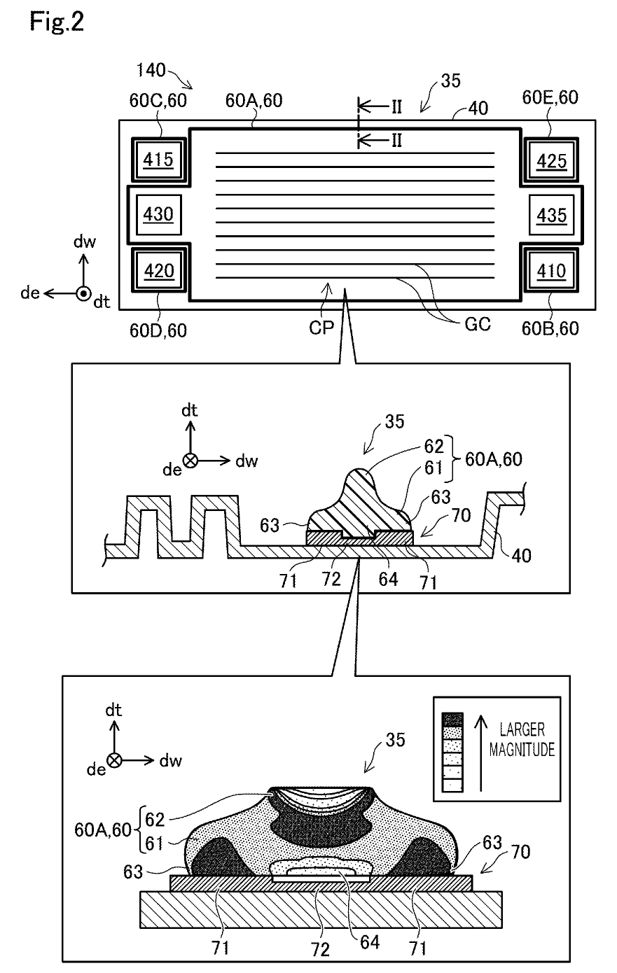

FIG. 2 is an explanatory diagram of a fuel cell sealing structure 35 in the first embodiment. An upper part of FIG. 2 shows the single cell 140 as viewed from the side in the stacking directionds. A middle part of FIG. 2 shows the single cell 140 shown on the upper part of FIG. 2, seen along the cross section line II-II. A lower part of FIG. 2 shows a compressed fuel cell sealing structure 35, which will be described later. As shown in FIG. 2, the fuel cell sealing structure 35 includes a sealing member 60, the separator 40, and an adhesive layer 70.

At least a portion of the separator 40 in the fuel cell sealing structure 35 corresponds to the “positioning portion” in the fuel cell sealing structure 35. The positioning portion is a portion in which the sealing member 60 is positioned and which is bonded to the sealing member 60 via the adhesive layer 70. The adhesive layer 70 is positioned between the positioning portion and the sealing member 60 and bonds the positioning portion and the sealing member 60 to each other. In the present embodiment, the adhesive layer 70 is formed using an adhesive containing an ultraviolet-curable resin. That is, the adhesive layer 70 is configured as a layer containing a cured adhesive.

The separator 40 includes a plurality of gas flow paths GC formed by uneven grooves at positions corresponding to the gas introduction paths. A portion of the separator 40 including the gas flow paths GC is also referred to as a central portion CP. Gas flowing through each manifold is supplied to the MEGA 21 via the gas introduction path and the gas flow path GC. The separator 50 also includes the gas flow paths GC and the central portion CP, as in the separator 40.

As shown in FIG. 2, the sealing member 60 is positioned above the separator 40. That is, the sealing member 60 is positioned between the separator 40 of one single cell 140 and a separator 50 of a next single cell 140 adjacent to the single cell 140, in the stacking direction ds. The sealing member 60 is configured as a gasket that seals a gap between the separator 40 and the separator 50. In the present embodiment, five sealing members 60A, 60B, 60C, 60D, and 60E are provided as the sealing member 60. The sealing member 60A is positioned to surround the coolant supply manifold 430, the coolant discharge manifold 435, and the central portion CP. The sealing members 60B, 60C, 60D, and 60E are positioned to surround the anode gas supply manifold 410, the anode gas discharge manifold 415, the cathode gas supply manifold 420, and the cathode gas discharge manifold 425, respectively.

In the present embodiment, the sealing member 60 is configured as an ultraviolet-curable Cured-In-Place Gasket (CIPG). That is, the sealing member 60 is formed by curing a sealing member precursor having fluidity, such as a liquid or paste, using ultraviolet light. In other embodiments, the sealing member 60 may be made of various elastic materials, such as rubber material or thermoplastic elastomer. Hereinafter, unless otherwise specified, the term “sealing member 60” simply refers to the cured sealing member 60.

As shown in FIG. 1, the sealing member 60 includes a base portion 61 and a protrusion 62. The base portion 61 is a wider portion in a width direction dw of the sealing member 60 than the protrusion 62. The width direction dw is orthogonal to a thickness direction dt and an extending direction de of the sealing member 60. The thickness direction dt is a direction along the stacking direction ds and is orthogonal to the extending direction de. As described later, the base portion 61 is bonded to the separator 40 via the adhesive layer 70.

The protrusion 62 is a portion protruding from the base portion 61 and is shaped to convex upward. A protruding direction in which the protrusion 62 protrudes is the direction along the thickness direction dt. A tip of the protrusion 62 in the protruding direction has a rounded curved shape. As described above, when the fuel cell 10 is fastened, the protrusion 62 is pressed from above by the separator 50. As a result, the sealing member 60 is compressed from above in the thickness direction dt. In the fuel cell 10 which has the stacked structure, the fastening pressure is maintained, thereby causing the sealing member 60 to remain in a compressed state. Due to such compression of the sealing member 60, a contact area between the sealing member 60 and the separator 50 increases, which ensures adhesion between the sealing member 60 and the separator 50. Hereinafter, the fuel cell sealing structure 35 including the sealing member 60 compressed in this way is also referred to as the “compressed fuel cell sealing structure 35”.

The adhesive layer 70 includes a first portion 71 and a second portion 72 in the width direction dw. The thickness of the second portion 72 is smaller than the thickness of the first portion 71. In the present embodiment, the second portion 72 is configured as a portion having a thickness greater than zero.

In the present embodiment, the first portion 71 is positioned at a location facing an end portion 63 of the sealing member 60 in the width direction dw. As used herein, the term “facing” such as describing the situation in which the sealing member 60 and the adhesive layer 70 face refers to the facing situation in the thickness direction dt. The end portion 63 is a portion of the sealing member 60 including an end thereof in the width direction dw. The second portion 72 is positioned at a location facing an inner portion 64 of the sealing member 60 in the width direction dw. The inner portion 64 is a portion of the sealing member 60 that is located on an inner side relative to the end portion 63 in the width direction dw. As shown in FIG. 2, in the present embodiment, the second portion 72 is positioned between two first portions 71 in a cross-section view along the extending direction de.

In the lower part of FIG. 2, a distribution of a shear stress generated in the compressed sealing member 60 is indicated by dotted hatching. The shear stress distribution represents the distribution of shear stress in a cross section of the sealing member 60. The term orthogonal cross section refers to a cross section taken in a direction orthogonal to the extending direction de. More specifically, in the lower part of FIG. 2, regions where a shear stress of a larger magnitude is generated are shown with denser hatching. The shear stress distribution shown in the lower part of FIG. 2 is obtained as a result of a compression simulation performed for compressing the fuel cell sealing structure 35. The compression simulation models the compression applied to the fuel cell sealing structure 35 in the fastened fuel cell 10. It should be noted that, during an actual use of the fuel cell 10, the sealing member 60 is subjected not only to shear stress arising from fastening compression but also to forces generated by fluids such as cathode gas, hydrogen, and coolant.

As shown in FIG. 2, the present inventors have found that, in the compressed sealing member 60, a shear stress of a relatively large magnitude is generated in the end portion 63, while a shear stress of a relatively small magnitude is generated in the inner portion 64. The present inventors have also found that the bonding strength achieved by the adhesive layer 70 tends to increase as the thickness of the adhesive layer 70 increases. Accordingly, in the present embodiment, by positioning the first portion 71 at a location facing the end portion 63, a higher bonding strength is ensured at the end portion 63 where a relatively high bonding strength is required. Furthermore, by positioning the second portion 72 at a location facing the inner portion 64 where the required bonding strength is relatively low, the increase in the amount of adhesive used to form the adhesive layer 70 is suppressed, for example, compared to a case where the adhesive layer 70 is composed of only the first portion 71.

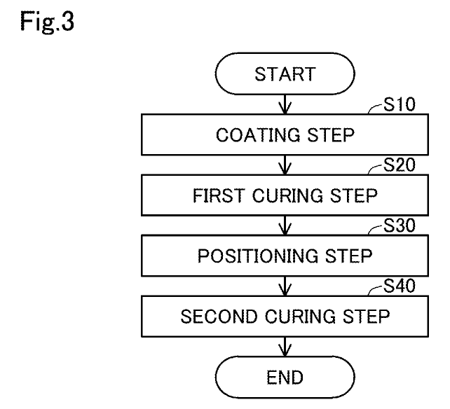

FIG. 3 is a process diagram showing a method for manufacturing the fuel cell sealing structure 35 in the present embodiment.

In Step S10, the coating step is performed. The coating step is a step of applying the adhesive to the positioning portion to form the adhesive layer 70. In the coating step of the present embodiment, the adhesive is applied to the separator 40 using an inkjet technology. More specifically, the adhesive is applied to the separator 40 by discharging the adhesive as droplets from a nozzle of an inkjet device to the separator 40. In other embodiments, during the coating step, the adhesive may be applied to the separator 40 using, for example, a syringe-type dispenser or a spray-type dispenser. The use of the inkjet technology or a dispenser in the coating step enables the application position and applied thickness of the adhesive to be controlled with higher precision. In particular, inkjet technology is useful when forming the adhesive layer 70 for bonding a relatively small-sized sealing member 60 having a width of approximately 2mm or less.

In the coating step of the present embodiment, the adhesive is applied in accordance with the shear stress distribution described above. By performing the coating step, an adhesive for forming the first portion 71 and a second adhesive for forming the second portion 72 are placed on the separator 40. In the coating step, the adhesive may also be described as being applied so as to form the first portion 71 and the second portion 72. By applying the adhesive in this way so as to form both the first portion 71 and the second portion 72, it becomes possible to suppress spreading of the adhesive outward beyond the sealing member 60 in the width direction dw, for example, compared to a case where the adhesive is applied so as to form only the first portion 71. As a result, a reduction in the amount of adhesive used is enabled. In addition, it also becomes possible to suppress formation of an extra layer containing an adhesive that does not contribute to bonding on the separator 40.

In Step S20, the first curing step is performed. The first curing step is a step of curing part of the adhesive applied in the coating step, the step being performed after the coating step. More specifically, in the first curing step, the adhesive applied is irradiated with ultraviolet light, thereby forming an adhesive layer precursor. The adhesive layer precursor includes a cured layer formed of a cured adhesive and an uncured layer formed of an uncured adhesive. The cured layer is formed on an inner side of the uncured layer. The uncured layer is formed so as to cover the cured layer. The uncured layer is formed by inhibiting curing of a portion of the adhesive located in the vicinity of its surface due to oxygen inhibition.

In Step S30, the positioning step is performed. The positioning step is a step of positioning the sealing member precursor on the adhesive layer precursor. In the positioning step of the present embodiment, the sealing member precursor having fluidity is molded on the adhesive layer precursor into a shape corresponding to the final shape of the sealing member 60 by using a molding die. At this time, an uncured portion is formed in which a lower end portion of the sealing member precursor and at least part of the uncured layer are integrated. The uncured portion is also referred to as an interfacial miscible layer.

In Step S40, the second curing step is performed. In the second curing step, the sealing member precursor and the uncured layer of the adhesive layer precursor are cured, thereby forming the sealing member 60 and the adhesive layer 70. During this process, the above uncured portion is cured, causing the sealing member 60 and the adhesive layer 70 to become fixed to each other. Once the second curing step is performed, the sealing member 60 is bonded to the separator 40 serving as the positioning portion via the adhesive layer 70, thereby forming the fuel cell sealing structure 35.

According to the fuel cell sealing structure 35 of the present embodiment described above, the adhesive layer 70 includes the first portion 71 and the second portion 72. The second portion 72 has a thickness smaller than the thickness of the first portion 71 in the width direction dw. Thus, the first portion 71 allows adequate bonding strength of the sealing member 60 to be ensured via the adhesive layer 70. In addition, by including the second portion 72, the adhesive layer 70 enables the suppression of an increase in the amount of adhesive used to form the adhesive layer 70. In this way, according to the present embodiment, it becomes possible to suppress an increase in the amount of adhesive used while ensuring the bonding strength.

In the present embodiment, the first portion 71 is positioned at a location facing the end portion 63 of the sealing member 60, while the second portion 72 is positioned at a location facing the inner portion 64 of the sealing member 60. With this configuration, it becomes possible to ensure a higher bonding strength at the end portion 63 where a shear stress of a relatively large magnitude tends to be generated, while enabling a reduction in the amount of adhesive used at the inner portion 64 where a shear stress of a relatively small magnitude tends to be generated. As a result, it becomes possible to effectively ensure bonding strength across both the end portion 63 and the inner portion 64, while suppressing an increase in the amount of adhesive used.

### Second Embodiment

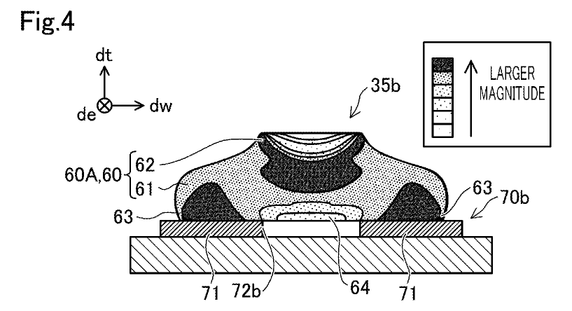

FIG. 4 is an explanatory diagram of a fuel cell sealing structure 35b in a second embodiment. Similar to the lower part of FIG. 2, FIG. 4 shows a distribution of a shear stress generated in the sealing member 60. As shown in FIG. 4, in the present embodiment, a second portion 72b is configured as a void. That is, the thickness of the second portion 72b in the present embodiment is zero. The second portion 72b corresponds to a through-hole that penetrates the adhesive layer 70b in the thickness direction dt. For the fuel cell sealing structure 35b in the second embodiment, points not specifically described herein are the same as those in the first embodiment. The second embodiment also enables the suppression of an increase in the amount of adhesive used while ensuring bonding strength. In particular, in the present embodiment, the second portion 72b configured as the void enables the suppression of an increase in the amount of adhesive used more effectively.

### Third Embodiment

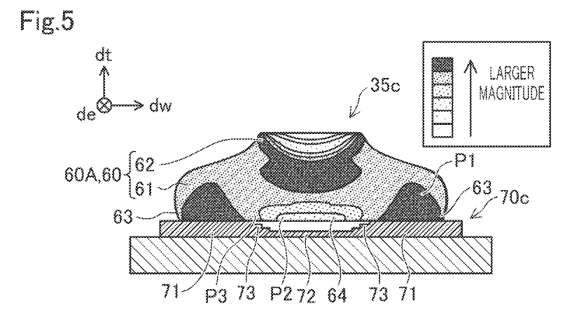

FIG. 5 is an explanatory diagram of a fuel cell sealing structure 35c in a third embodiment. Similar to FIG. 4, FIG. 5 shows a shear stress distribution in the sealing member 60. As shown in FIG. 5, in the present embodiment, an adhesive layer 70c further includes a third portion 73 in the width direction dw. The third portion 73 is positioned between the first portion 71 and the second portion 72 in the width direction dw. The thickness of the third portion 73 is smaller than that of the first portion 71 and larger than that of the second portion 72. When the second portion 72 is configured as a void, the thickness of the third portion 73 only needs to be greater than zero. In the present embodiment, the third portion 73 is formed by increasing the thickness of the adhesive layer 70c stepwise from the second portion 72 toward the first portion 71. For the fuel cell sealing structure 35c in the third embodiment, points not specifically described are the same as those in the first embodiment.

In the present embodiment, the first portion 71, the second portion 72, and the third portion 73 are positioned at respective locations in the width direction dw corresponding to the shear stress distribution in the sealing member 60 after compression. More specifically, the first portion 71 is positioned at a location facing a portion P1 where a shear stress of a first magnitude is generated in the width direction dw. The second portion 72 is positioned at a location facing a portion P2 where a shear stress of a second magnitude is generated in the width direction dw. The second magnitude is smaller than the first magnitude. The third portion 73 is positioned at a location facing a portion P3 where a shear stress of a third magnitude is generated in the width direction dw. The third magnitude is smaller than the first magnitude and larger than the second magnitude. In addition, in the present embodiment, the first portion 71 and the third portion 73 are positioned adjacent to each other in the width direction dw.

According to the fuel cell sealing structure 35c of the third embodiment described above, the adhesive layer 70c further includes the third portion 73 positioned between the first portion 71 and the second portion 72 in the width direction dw. The thickness of the third portion 73 is smaller than that of the first portion 71 and larger than that of the second portion 72. Even when, during the manufacturing process of the fuel cell sealing structure 35c, the location where the sealing member 60 is positioned relative to the adhesive layer 70c is slightly misaligned in the width direction dw, bonding of a portion originally intended to be bonded by the first portion 71 becomes possible by using the third portion 73, which provides a higher bonding strength than the second portion 72. Thus, according to the present embodiment, since the third portion 73 adjacent to the first portion 71 ensures a higher bonding strength than the second portion 72, this arrangement allows a greater tolerance for positional misalignment of the sealing member 60 in the width direction dw relative to the adhesive layer 70c, while still suppressing an increase in the amount of adhesive used. That is, even when positional misalignment occurs, the present embodiment is more likely to ensure a relatively high bonding strength, compared with a configuration that does not include the third portion 73. In particular, in the present embodiment, because the first portion 71 and the third portion 73 are positioned adjacent to each other in the width direction dw, positional misalignment is allowed even more effectively.

Furthermore, according to the present embodiment, the first portion 71, the second portion 72, and the third portion 73 are positioned at the respective locations corresponding to the shear stress distribution in the sealing member 60. This more effectively enables the suppression of an increase in the amount of adhesive used, while ensuring the bonding strength.

### Fourth Embodiment

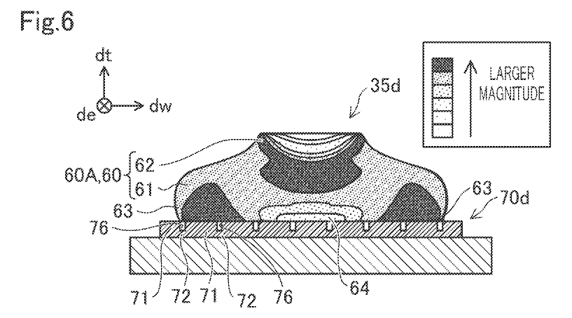

FIG. 6 is an explanatory diagram of a fuel cell sealing structure 35d in a fourth embodiment. Similar to FIG. 4, FIG. 6 shows a shear stress distribution in the sealing member 60. As shown in FIG. 6, in the present embodiment, an adhesive layer 70d includes a plurality of first portions 71 and a plurality of second portions 72 in the width direction dw. In the width direction dw, each of the plurality of second portions 72 is positioned between adjacent first portions 71. As a result, the adhesive layer 70d includes a plurality of recesses 76 partitioned by the first portions 71 and second portions 72. The plurality of recesses 76 are arranged side by side along the width direction dw and face the sealing member 60. That is, each recess 76 is open upward toward the sealing member 60. For the fuel cell sealing structure 35d in the fourth embodiment, points not specifically described are the same as those in the first embodiment. According to the present embodiment, by utilizing the plurality of recesses 76 formed by the plurality of first portions 71 and second portions 72, an anchoring effect is allowed to be suitably exhibited between the sealing member 60 and the adhesive layer 70d, thereby further enhancing the bonding strength. Furthermore, in the present embodiment, the use of the recesses 76 enables the sealing member 60 to be fixed to the positioning portion through the anchoring effect, without forming irregularities on the surface of the separator 40 by a surface treatment such as sandblasting. As a result, for example, it becomes possible to suppress deterioration of electrical properties of the separator 40 due to the surface treatment.

### Other Embodiments

(E1) In the above-described embodiments, in the coating step, the adhesive does not necessarily have to be applied according to the shear stress distribution. The first portion 71 and the second portion 72 do not need to be positioned at locations corresponding to the shear stress distribution. Similarly, the third portion 73 does not need to be positioned at a location corresponding to the shear stress distribution.

(E2) In the above-described third embodiment and the fourth embodiment, similar to the second embodiment, the second portion 72 may be configured as a void. In the above-described second embodiment and the fourth embodiment, similar to the third embodiment, the third portion 73 may be positioned between the first portion 71 and the second portion 72.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the present disclosure, a fuel cell sealing structure is provided. The fuel cell sealing structure includes: a sealing member; a positioning portion in which the sealing member is positioned, the positioning portion being bonded to the sealing member; and an adhesive layer positioned between the positioning portion and the sealing member and configured to bond the positioning portion and the sealing member to each other. The adhesive layer includes, in a width direction of the sealing member, a first portion and a second portion, the second portion having a thickness smaller than a thickness of the first portion or that is a void.

According to this aspect, the first portion of the adhesive layer allows adequate bonding strength of the sealing member to be ensured via the adhesive layer. In addition, by including the second portion, the adhesive layer enables the suppression of an increase in the amount of adhesive used to form the adhesive layer. In this way, suppression of an increase in the amount of adhesive used is enabled, while ensuring the bonding strength.

(2) In the above-described aspect, the first portion may be positioned at a location facing an end portion of the sealing member, the end portion including an end thereof in the width direction, and the second portion may be positioned at a location facing an inner portion of the sealing member that is located on an inner side relative to the end portion in the width direction. According to this aspect, it becomes possible to ensure a higher bonding strength at the end portion where a shear stress of a relatively large magnitude tends to be generated, while enabling a reduction in the amount of adhesive used at the inner portion where a shear stress of a relatively small magnitude tends to be generated. As a result, it becomes possible to effectively ensure bonding strength across both the end portion and the inner portion, while suppressing an increase in the amount of adhesive used.

(3) In the above-described aspect, the adhesive layer may include a third portion positioned between the first portion and the second portion in the width direction, and the third portion may have a thickness smaller than the thickness of the first portion and larger than the thickness of the second portion. According to this aspect, since the third portion adjacent to the first portion ensures a higher bonding strength than the second portion, this arrangement allows a greater tolerance for positional misalignment of the sealing member in the width direction with respect to the adhesive layer, while still suppressing an increase in the amount of adhesive used.

(4) In the above-described aspect, the first portion, the second portion, and the third portion may be positioned at respective locations corresponding to a distribution of a shear stress in the width direction, the shear stress being generated in the sealing member when the fuel cell sealing structure is compressed along a thickness direction of the sealing member, the first portion may be positioned at a location facing a portion where the shear stress of a first magnitude is generated, the second portion may be positioned at a location facing a portion where the shear stress of a second magnitude smaller than the first magnitude is generated, and the third portion may be positioned at a location facing a portion where the shear stress of a third magnitude is generated, the third magnitude being smaller than the first magnitude and larger than the second magnitude. According to this aspect, suppression of an increase in the amount of adhesive used is enabled more effectively while ensuring the bonding strength.

(5) In the above-described aspect, the adhesive layer may include a plurality of the first portions and a plurality of the second portions, and each of the plurality of first portions may be positioned between adjacent ones of the second portions. According to this aspect, by utilizing the plurality of recesses formed by the plurality of first portions and the plurality of second portions, an anchoring effect is allowed to be suitably exhibited between the sealing member and the adhesive layer, thereby further enhancing the bonding strength.

The present disclosure may be embodied in forms other than the fuel cell sealing structure described above, for example, in the form of a fuel cell, a method for manufacturing a fuel cell sealing structure, a method for manufacturing a fuel cell, and the like.

What is claimed is:

1. A fuel cell sealing structure, comprising:
a sealing member;
a positioning portion in which the sealing member is positioned, the positioning portion being bonded to the sealing member; and
an adhesive layer positioned between the positioning portion and the sealing member and configured to bond the positioning portion and the sealing member to each other, wherein
the adhesive layer includes, in a width direction of the sealing member, a first portion and a second portion, the second portion having a thickness smaller than a thickness of the first portion or being a void.

2. The fuel cell sealing structure according to claim 1, wherein
the first portion is positioned at a location facing an end portion of the sealing member, the end portion including an end thereof in the width direction, and
the second portion is positioned at a location facing an inner portion of the sealing member, the inner portion being located on an inner side relative to the end portion in the width direction.

3. The fuel cell sealing structure according to claim 1, wherein
the adhesive layer includes a third portion positioned between the first portion and the second portion in the width direction, and
the third portion has a thickness smaller than the thickness of the first portion and larger than the thickness of the second portion.

4. The fuel cell sealing structure according to claim 3, wherein
the first portion, the second portion, and the third portion are positioned at respective locations corresponding to a distribution of a shear stress in the width direction, the shear stress being generated in the sealing member when the fuel cell sealing structure is compressed along a thickness direction of the sealing member,
the first portion is positioned at a location facing a portion where the shear stress of a first magnitude is generated,
the second portion is positioned at a location facing a portion where the shear stress of a second magnitude smaller than the first magnitude is generated, and
the third portion is positioned at a location facing a portion where the shear stress of a third magnitude is generated, the third magnitude being smaller than the first magnitude and larger than the second magnitude.

5. The fuel cell sealing structure according to claim 1, wherein
the adhesive layer includes a plurality of the first portions and a plurality of the second portions, along the width direction, and
each of the plurality of second portions is positioned between adjacent ones of the first portions.
